(19) United States
(12) Patent Application Publication
(10) Pub. No.: US 2014/0144421 A1
(43) Pub. Date: May 29, 2014

(54) CUTTING MACHINE AND METHOD OF CUTTING

(71) Applicant: Eng Hwa Chua, Singapore (SG)

(72) Inventor: Eng Hwa Chua, Singapore (SG)

(21) Appl. No.: 14/129,067

(22) PCT Filed: Jun. 20, 2012
(86) PCT No.: PCT/SG2012/000222

§ 371 Date: Dec. 23, 2013

(30) Foreign Application Priority Data
Jun. 23, 2011 (SG) 201104704-0

(51) Int. Cl. B23D 57/00

(52) U.S. Cl. CPC B23D 57/0007
USPC 125/21

(57) ABSTRACT

A cutting machine for cutting an ingot; the cutting machine comprising a carrier configured to attach the ingot thereonto, a plurality of wires configured to cut the ingot, and a container configured to flow water onto the plurality of wires and the ingot during cutting and to submerge cut portions of the ingot in water in the container without submerging the plurality of wires.

### FIELD OF THE INVENTION

This invention relates to a cutting machine and a method of cutting and refers particularly, though not exclusively, to a cutting machine for cutting an ingot such as, for example, an ingot of a semiconductor or other material, and a method of cutting such an ingot.

### BACKGROUND OF THE INVENTION

The cutting of ingots, such as, for example, of semiconductor material is normally performed by using a large number of parallel fine wires to perform the cutting action in the presence of a slurry that is sprayed onto the wires as they contact the ingot. The ingot material may be silicon and the cutting may be to produce individual wafers for fabrication of devices for various industries such as semiconductors, solar and many others.

The use of a slurry necessitates a slurry recycling plant, and also requires ancillary systems such as chillers, temperature management systems, and pumps that are not only complex and costly but are also energy inefficient. All of this requires a very large capital outlay as well as substantial running cost.

Although diamond wires are preferred due to their superior cutting action, they cannot normally be used as they clog with the semiconductor material. This will often require them to be regularly replaced, thereby making their use very expensive.

Furthermore, the use of normal cutting wires can slow the cutting speed, and result in cuts that are inconsistent thereby providing less useful results. It also results in lower yield, more waste and low throughput. This may mean, for example, fewer useable wafers from a given ingot, and inconsistent thickness of the wafers. Wafers that are uneven in thickness may result in reduced or uneven quality of semiconductors.

### SUMMARY OF THE INVENTION

According to a first exemplary aspect, there is provided a cleaning device for a wire in a cutting machine, the cleaning device comprising a through hole configured to allow passage of the wire therethrough; and a conically shaped annular gap configured to focus an annular air jet onto the wire passing through the cleaning device for cleaning and drying the wire, the conically shaped annular gap being in fluid communication and co-axial with the through hole.

The cleaning device may further comprise an air inlet configured to direct compressed dry air into the conically shaped annular gap.

The cleaning device may comprise at least two portions, a first portion comprising a central recess having a conical base, and a second portion comprising a central shaft having a conical end, wherein the conically shaped annular gap is formed by spacing the conical end from the conical base. The air inlet may be provided in the first portion.

The cleaning device may further comprise a conical depression at one end of the through hole into which the annular air jet is focused.

According to a second exemplary aspect, there is provided a cutting machine for cutting an ingot; the cutting machine comprising a carrier configured to attach the ingot thereonto; a plurality of wires configured to cut the ingot; and a container configured to flow water onto the plurality of wires and the ingot during cutting and to submerge cut portions of the ingot in water in the container without submerging the plurality of wires.

The cutting machine may further comprise at least one dancer configured to control wire tension during operation.

The dancer may be configured to be moveable to increase total distance travelled by a wire to increase wire tension, and to decrease total distance travelled by the wire to decrease the tension.

The cutting machine may further comprise at least one wire tension sensor configured to detect wire tension, wherein movement of the dancer is in response to the detected wire tension.

The cutting machine may further comprise a wire positioner configured to position a wire relative to a wire drum when winding the wire onto the wire drum and when unwinding the cutting wire from the wire drum, the plurality of wires being formed from the wire. The wire positioner may further comprise a wire displacement sensor configured to detect the position of the wire relative to the wire drum.

The cutting machine may further comprise a control system configured to control movement of the wire positioner in response to the detected position of the wire. The control system may be further configured to control movement of the dancer in response to the detected wire tension.

The cutting machine may further comprise the cleaning device of the first exemplary aspect.

According to a third exemplary aspect, there is provided a method of cutting an ingot, the method comprising attaching an ingot onto a carrier; lowering the ingot to contact a plurality of wires; flowing water onto the plurality of wires and the ingot during cutting; and submerging cut portions of the ingot in water without submerging the plurality of wires.

The method may further comprise periodically raising the ingot during operation such that the plurality of wires are run against the cut portions of the ingot during the raising, thereby improving surface quality of the cut portions of the ingot.

The plurality of wires may be formed from a wire, and the method may further comprise cleaning the wire after cutting by passing the wire through a wire cleaning device prior to winding the wire onto a wire receiver drum.

The method may further comprise positioning the wire with respect to the wire receiver drum by passing the wire through a wire displacement sensor after cleaning the wire and prior to winding the wire onto the wire receiver drum.

The method may further comprise, before cutting, positioning the wire relative to a wire feeder drum by passing the wire through a wire displacement sensor after unwinding the wire from a wire feeder drum.

The method may further comprise controlling tension of the wire by controlling movement of a dancer around which the wire is passed, wherein movement of the dancer is in response to wire tension detected by a wire tension sensor.

Controlling tension of the wire may comprise moving the dancer to increase total distance travelled by the wire to increase wire tension when the detected wire tension is lower than a predetermined wire tension, and moving the dancer to decrease total distance travelled by the wire to decrease wire tension when the detected wire tension is higher than the predetermined wire tension.

The above features and advantages, along with other related features and advantages, will be readily apparent to skilled persons from the description below.

### BRIEF DESCRIPTION OF THE DRAWINGS

In order that the invention may be fully understood and readily put into practical effect, there shall now be described by way of non-limitative example only exemplary embodiments, the description being with reference to the accompanying illustrative drawings. In the drawings:

FIG. 1 is a schematic illustration of an exemplary embodiment of the cutting machine;

FIG. 2 is a schematic illustration of a cutting station of the cutting machine of FIG. 1;

FIG. 3 is a schematic illustration of a cutting station of the cutting machine of FIG. 1;

FIG. 4 is a schematic perspective view of a dancer and CCD laser displacement sensor of the cutting machine of FIG. 1;

FIG. 5 is a schematic perspective view of a cleaning device of the cutting machine of FIG. 1;

FIG. 6 is a schematic perspective view of a first portion of the cleaning device of FIG. 5;

FIG. 7 is a schematic cross-sectional view of the cleaning device of FIG. 5; and

FIG. 8 is a flowchart of an exemplary cutting method.

### DETAILED DESCRIPTION OF THE EXEMPLARY EMBODIMENTS

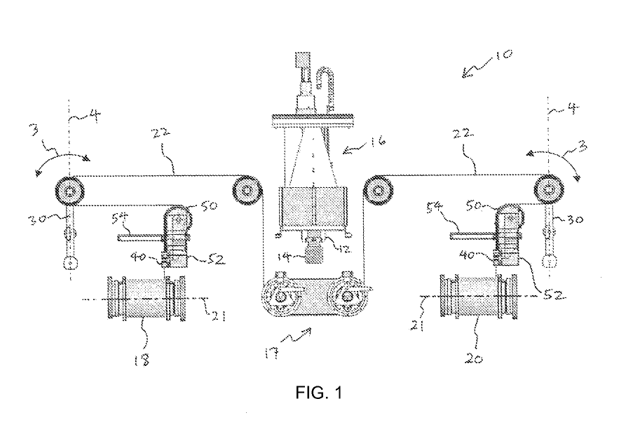

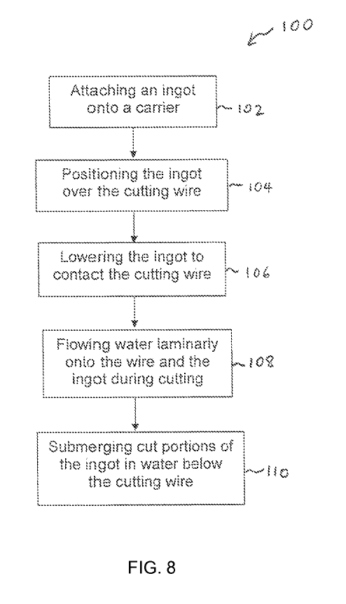

Exemplary embodiments of the cutting machine 10 and component parts as well as a method 100 of cutting are described below with reference to FIGS. 1 to 8.

As shown in FIGS. 1 to 3, the cutting machine 10 comprises a carrier 12 for supporting one or one or more ingots 14 of a material to be cut into a number of separate components. The cutting machine 10 also comprises a cutting station 17 which has a wire 22 configured to act as a plurality of wires 23 for making simultaneous multiple cuts in the ingot 14. Cutting is achieved by running the plurality of wires 23 against the ingot 14. The wire 22 is supplied to the cutting station 17 via a first wire drum 18 and a second wire drum 20. Both the wire drums 18, 20 may be cylindrical drums of known construction, as shown. The machine 10 may operate in a forward mode where the wire 22 is supplied to the cutting station 17 by the first wire drum 18 acting as a wire feeder drum and received from the cutting station 17 by the second wire drum 20 acting as a wire receiver drum; and in a reverse mode where the wire 22 is supplied to the cutting station 17 by the second wire drum 20, now acting as the wire feeder drum, and received from the cutting station 17 by the first wire drum 18, now acting as the wire receiver drum.

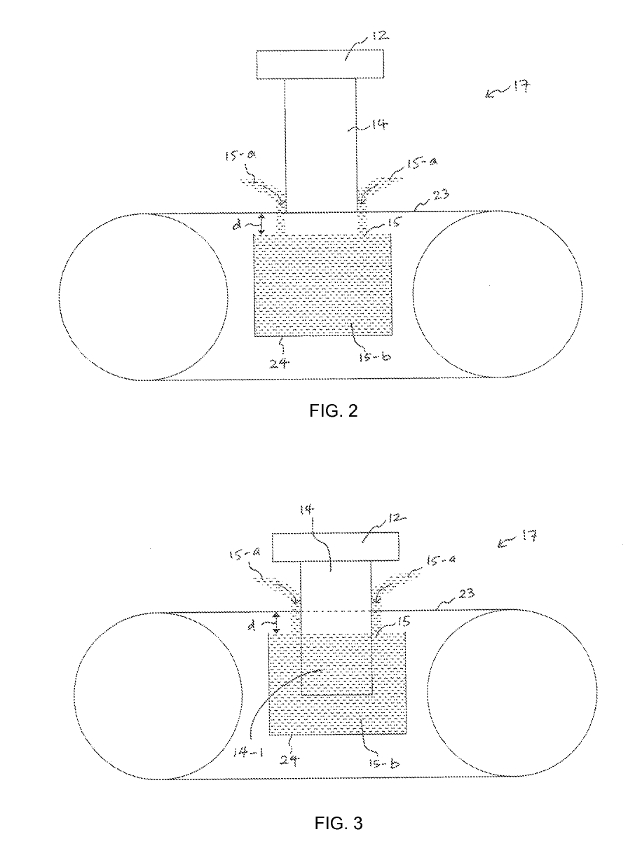

During the cutting, first, the ingot 14 is attached to a bottom surface of the carrier 12 (102) by an epoxy, adhesive, or the like, in a known manner. The carrier 12 is mounted for longitudinal movement relative to a support assembly 16 and is moved together with the ingot 14 until the ingot 14 is correctly located above a cutting station 17 (104). The support assembly 16 together with the carrier 12 and the ingot 14 are then lowered until a bottom of the ingot 14 contacts the plurality of wires 23 in the cutting station 17 (106), as shown in FIG. 2.

The cutting machine 10 further comprises a container 24 configured to hold a cutting liquid 15 such as water 15 for wetting the plurality of wires 23 during cutting of the ingot 14. A water supply and filtration system (not shown) of known construction may be provided to supply the cutting machine 10 with the water 15. During cutting, the ingot 14 is continually being lowered against the plurality of wires 23 while water 15-a is flowed over the plurality of wires 23 and the ingot 14 being cut (108), as shown by the arrows in FIG. 2. Preferably, a laminar flow is maintained at all times during cutting such that cutting of the ingot 14 takes place in a laminar flow of water 15-a without submerging the plurality of wires 23.

The plurality of wires of the cutting station 17 are disposed above a top portion of the container 24. The container 24 is configured to collect the water 15-a flowed onto the plurality of wires 23 so that as the ingot 14 is continually lowered during cutting, the cut portions 14-1 of the ingot 14 become submerged in the water 15-b in the container (110) as shown in FIG. 3. This is achieved by maintaining the water level in the container 24 at a height sufficient to substantially submerge the cut portions 14-1 of the ingot 14 in the water 15-b while ensuring that the plurality of wires 23 remains at a distance d of about 10 to 30 mm above the surface of the water 15-b in the container 24.

By submerging the cut portions 14-1 of the ingot 14 in water 15-b while the rest of the ingot 14 is being cut by the plurality of wires 23 above the water 15-b in the container, the cut portions 14-1 can be efficiently cooled because heat resulting from the cutting process is more efficiently dissipated into the larger volume of water 15-b in the container 24 compared to the amount of water 15-a that is being flowed over the plurality of wires 23 and the part of the ingot 14 being cut. This reduces energy demands in terms of the cooling requirements of the machine 10, and represents a further advancement in green technology in this area.

It has also been established that the finish of the cut portions 14-1, which may be in the form of sliced wafers, is equally good and is not diminished even at much higher cutting speeds, and there is no surface damage when compared to the conventional cutting process, which results in a much greater throughput with greater cutting speeds.

Furthermore, there is significant reduction in breakage of the cut portions 14-1 or wafers as the already cut portions 14-1 are submerged in the water 15-b such that the water 15-b acts as a liquid support medium for the cut portions 14-1. Such support prevents the cut portions 14-1 or wafers from “collapsing,” an effect that would damage them 14-1, especially so during handling after cutting is completed. This results in a significant and direct improvement in the process throughput and yield. This becomes even more critical with the trend towards cutting ever thinner wafers with a view to reducing kerf loss in order to save the precious silicon, which forms a substantial portion of the overall cost of a silicon cell.

It has been found that mono-crystalline materials, when sawed using diamond wire, show nearly the same surface quality as those sawed using conventional slurry-based systems. On the other hand, multi-crystalline materials that were sawed using diamond wire displayed more surface damage when compared with the conventional slurry based systems. Evidence shows that multi-crystalline surfaces that were sawed using a diamond wire have a different structure. Grooves can be clearly discerned and ingots of multi-crystalline material generally display more surface damage when cut by diamond wires compared to monocrystalline ingots.

To improve the surface finish of the cut portions 14-1 of multi-crystalline ingots, the ingot 14 may be periodically raised during cutting so as to run the plurality of cutting wires 23 again over the already cut portions 14-1. In this way, the cut portions 14-1 experience more than one pass against the plurality of cutting wires 23 so that a smoothening effect on the surface of the cut portions 14-1 is achieved.

For example, a first cutting cycle may comprise the ingot 14 being lowered and cut through to a depth of 10 mm. Depth reference is taken from the plane of the plurality of wires 23. Keeping the plurality of wires 23 running, the ingot 14 is then retracted 6 mm upwards, to a depth of 4 mm, and again lowered to a depth of 10 mm. In second cutting cycle, the same ingot 14 is lowered and cut through to a depth of 15 mm. The ingot 14 is then raised 6 mm upwards to a depth of 9 mm, that is, 1 mm higher than the point to which it was lowered in the previous cycle (10 mm depth). The ingot 14 is then lowered again to a depth of 15 mm. In the third cutting cycle, the same ingot 14 is lowered and cut through to a depth of 20 mm, then raised 6 mm to a depth of 14 mm and again lowered to the depth of 20 mm. It can thus be observed that in each cutting cycle, the ingot 14 is cut deeper by an additional 5 mm, and raised 6 mm before being lowered again for further cutting. Multiple cutting cycles are thus performed in order to cut the complete ingot 14 all the way through.

It is envisaged that the cutting cycle may comprise cutting the ingot 14 to a different additional depth and raising the ingot 14 by a different distance than given in the example above. It is also envisaged that the depth of lowering and cutting and the distance raised may vary between cycles for cutting the same ingot. The depth and distances used will depend on the material of the ingot 14 being cut and how many additional passes are considered sufficient for achieving the desired surface finish of the cut portions 14-1.

It has been noted that wire tension, which is the tension on the wire 22 during cutting of the ingot 14, has a very significant role to play in the overall quality and throughput as well as the yield of the machine 10. It is, therefore, crucial to maintain the wire tension within a close tolerance.

Constant tension on the wire 22 throughout the entire cutting process may be achieved by providing a tension control dancer 30 on each side of the cutting station 17, together with one or more tension sensors (not shown) provided at various locations along the path of the wire 22, such as at an appropriate wire guide 50, as shown in FIG. 1. A tension sensor may comprise a suitable load cell. The load cell is able to measure the force that the wire 22 is applying onto the load cell and to transmit this as a tension reading to a control system (not shown). Each dancer 30 is designed to be capable of rotational movement as shown by the arrows 3 in the vertical plane, on each side of the vertical position indicated by axes 4 as shown in FIG. 1.

If the control system receives a tension reading from the load cell that is below a predetermined acceptable wire tension, this is an indication that wire tension has slackened and that the wire 22 may become loose as a result. Consequently, the control system instructs the dancer 30 to rotate in a direction that makes the wire 22 taut so as to take up slack in the wire 22, thereby restoring proper wire tension. This is achieved by rotation of the dancer 30 in a direction that results in an increase in the total distance traversed by the wire 22 in the machine 10. On the other hand, if the wire 22 becomes too taut as detected by the tension sensor, and tension undesirably increases as a result, the dancer 30 is instructed by the control system to rotate in the opposite direction to reduce the wire tension. The amount and direction of rotation of the dancer 30 is thus configured to correspond to the wire tension detected by the tension sensors. Control of the wire tension via the tension sensors, control system and the dancer 30 is configured to take place continually and in real-time throughout the cutting process. In this way, a desired wire tension that is required to achieve greatest cutting efficiency can always be maintained.

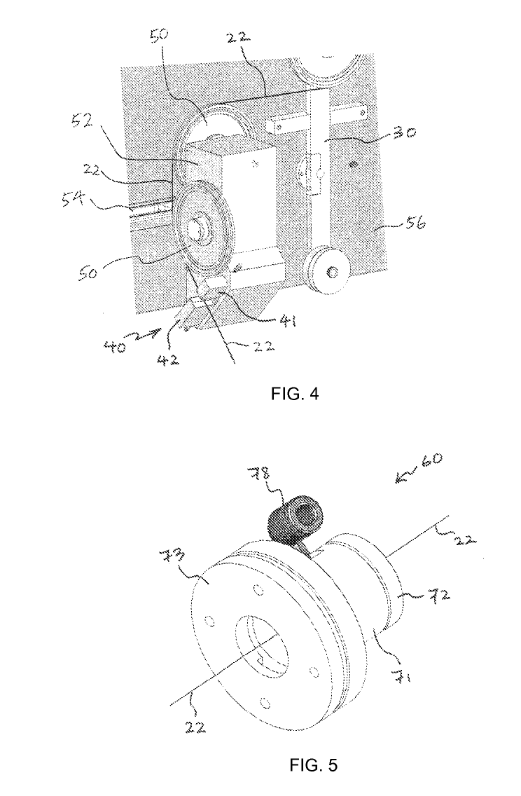

A wire displacement sensor such as a CCD laser displacement sensor 40 as shown in FIGS. 1 and 4 is preferably also provided in the cutting machine 10 for each of the wire drums 18, 20. The cutting machine 10 thus preferably comprises two CCD laser displacement sensors 40. Each CCD laser displacement sensor 40 is preferably disposed on a wire positioner 52 that positions the wire 22 relative to each wire drum 18 or 20. Each wire positioner 52 comprises a number of wire guides 50 configured to direct the wire 22 onto the wire receiver drum after cutting, and to properly position the wire 22 as it is unwound from the wire feeder drum for cutting. Proper positioning of the wire as it is unwound is important since the wire drums 18, 20 are typically obtained from a wire supplier and the supplied winding of the wire on the wire drums may not be as uniform or even as required for the cutting operation.

Each wire positioner 52 is mounted on a precision guide rail 54 provided on a side wall 56 of the machine 10 and configured to move only parallel to the cylindrical axis 21 of its respective wire drum 18 or 20. The CCD laser displacement sensor 40 detects the precise position of the wire 22 as it unwinds from the wire feeder drum 18, 20 or winds onto the wire receiver drum 20,18 respectively. Each CCD laser displacement sensor 40 comprises an emitter 41 and a receiver 42 between which the wire 22 is passed. A series of beams are emitted from the emitter 41 to the receiver 42 and are used to detect the exact position of the wire 22 between the emitter 41 and the receiver 42 continuously and at all times during cutting.

A particular position of the wire 22 between the emitter 41 and the receiver 42 has been preset as the correct position of the wire 22 relative to both the wire positioner 52 and the wire drum 18 or 20 during operation. Preferably, the correct position is where the wire 22 is at the exact centre of the CCD laser displacement sensor 40. The control system monitors the wire position detected by the wire displacement sensor 40 and controls the movement of the wire positioner 52 so to keep the wire 22 at the correct position between the emitter 41 and the receiver 42 while the wire 22 is wound onto or unwound from the wire drum 18 or 20. The wire positioner 52 thus continually moves along the precision guide rail 54 as the wire 22 is being wound onto or unwound from the wire drum 18 or 20. It is critical that the unwinding wire 22 is at the correct position because a deviated position would increase tension on the wire 22 resulting in wire breakage, and a deviated position would also result in the wire 22 being not synchronous with or not in concert with a desired winding pitch on the cutting station 17 to correctly form the plurality of wires 23.

Detection of the wire 22 by the CCD laser displacement sensor 40 is unfortunately adversely affected by the presence of water droplets on the wire 22 as well as the presence of other foreign matter such as solvent, oil, dirt, etc., which can cause the CCD laser displacement sensor 40 to send a wrong signal to the control system. Therefore, it is essential to efficiently clean the wire 22 before it passes through the CCD laser displacement sensor 40 so that the wire 22 is totally free of all such particles or water. Cleaning of the wire 22 is also desirable for proper winding of the wire 22 onto the wire drum 18 or 20 since foreign matter can obstruct proper placement of the wire on the wire drum 18 or 20.

Cleaning is achieved by means of a cleaning device 60 as shown in FIGS. 5 to 7. Two such cleaning devices 60 are preferably provided on the machine 10, with each cleaning device 60 positioned such that the wire 22 passes through the cleaning device 60 before passing through the CCD laser displacement sensor 40 to be wound onto the wire drum 20 or 18 acting as the wire receiver drum, in either the forward or reverse operation mode respectively.

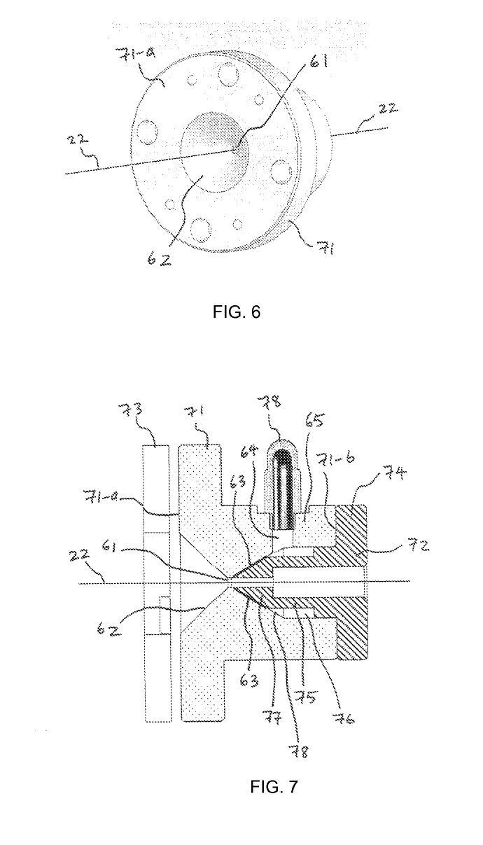

The cleaning device 60 may comprise two separable, co-axial portions 71, 72 together with a co-axial mounting ring 73 for attaching the cleaning device 60 to the machine 10. The cleaning device 60 preferably comprises a central hole 61 through both co-axial portions 71, 72, through which the wire 22 passes. The central hole 61 may comprise a conical depression 62 at a first end 71-a of the first portion 71 as shown in FIG. 6. The central hole 61 is in fluid communication with a very narrow conically shaped annular gap 63 formed within the cleaning device 60, as shown by the thickened black lines in FIG. 7. The conically shaped annular gap 63 is preferably co-axial with the central hole 61. The conically shaped annular gap 63 is in turn in fluid communication with an air inlet 64 preferably provided in a side wall 65 of the cleaning device 60.

The conical depression 62 and air inlet 64 through the side wall 65 of the cleaning device 60 are preferably provided in the first portion 71. The second portion 72 preferably comprises an annular flange 74 for engaging a second end 71-b of the first portion 71, and a central shaft 75 configured to be disposed within a central recess 76 provided in the second end 71-b of the first portion 71. The central shaft 75 comprises a conical end 77 while the central recess 76 comprises a corresponding conical base 78. By spacing the conical end 77 from the conical base 78, the conically shaped annular gap 63 within the cleaning device 60 is thereby formed.

Compressed dry air is blown under pressure into the cleaning device 60 through a fitting 78 provided at the air inlet 64. As the compressed dry air is forced through the very narrow conically shaped annular gap 63 into the space defined by the conical depression 62, it forms a focusing annular air jet against the wire 22 that is passing through the central hole 61, thereby rapidly drying and cooling the wire 22, and at the same time blowing off any accumulated particles or foreign matter. The space defined by the conical depression 62 serves to contain water and other debris that is blown off the wire 22, as well as the air jet emanating from the conically shaped annular gap 63. Continuous, all-round, 360-degree cleaning and drying of the wire 22 is therefore achieved by the cleaning device 60 before the wire 22 is allowed to pass through the CCD laser displacement sensor 40. The cleaning device 60 therefore performs a crucial function for proper operation of the machine 10 to ensure accurate position reading by the CCD laser displacement sensor 40 for precise winding of the wire 22 onto the wire receiver drum. A provision is preferably also made to drain away the water droplets and other dirt and residue away from the machine interior.

Whilst the foregoing description has described exemplary embodiments, it will be understood by those skilled in the technology concerned that many variations in details of design, construction and/or operation may be made without departing from the present invention. For example, in the cleaning device 60, the air inlet 64 may be provided in the second portion 72 instead of the first portion 71. The conical depression 62 may be omitted.

1. A cleaning device for a wire in a cutting machine, the cleaning device comprising:
a through hole configured to allow passage of the wire therethrough; and
a conically shaped annular gap configured to focus an annular air jet onto the wire passing through the cleaning device for cleaning and drying the wire, the conically shaped annular gap being in fluid communication and co-axial with the through hole.

2. The cleaning device of claim 1, further comprising an air inlet configured to direct compressed dry air into the conically shaped annular gap.

3. The cleaning device of claim 1, wherein the cleaning device comprises at least two portions, a first portion comprising a central recess having a conical base, and a second portion comprising a central shaft having a conical end, wherein the conically shaped annular gap is formed by spacing the conical end from the conical base.

4. The cleaning device of claim 3, further comprising an air inlet configured to direct compressed dry air into the conically shaped annular gap, wherein the air inlet is provided in the first portion.

5. The cleaning device of claim 1, further comprising a conical depression at one end of the through hole into which the annular air jet is focused.

6. A cutting machine for cutting an ingot; the cutting machine comprising:
a carrier configured to attach the ingot thereonto;
a plurality of wires configured to cut the ingot; and
a container configured to flow water onto the plurality of wires and the ingot during cutting and to submerge cut portions of the ingot in water in the container without submerging the plurality of wires.

7. The cutting machine of claim 6, further comprising at least one dancer configured to control wire tension during operation.

8. The cutting machine of claim 7, wherein the dancer is configured to be moveable to increase total distance travelled by a wire to increase wire tension, and to decrease total distance travelled by the wire to decrease the tension.

9. The cutting machine of claim 8, further comprising at least one wire tension sensor configured to detect wire tension, wherein movement of the dancer is in response to the detected wire tension.

10. The cutting machine of claim 6, further comprising a wire positioner configured to position a wire relative to a wire drum when winding the wire onto the wire drum and when unwinding the cutting wire from the wire drum, the plurality of wires being formed from the wire, the wire positioner further comprising a wire displacement sensor configured to detect the position of the wire relative to the wire drum.

11. The cutting machine of claim 10, further comprising a control system configured to control movement of the wire positioner in response to the detected position of the wire.

12. The cutting machine of claim 11, further comprising at least one dancer configured to control wire tension during operation, wherein the dancer is configured to be moveable to increase total distance travelled by a wire to increase wire tension, and to decrease total distance travelled by the wire to decrease the tension, the cutting machine further comprising at least one wire tension sensor configured to detect wire tension, wherein movement of the dancer is in response to the detected wire tension, wherein the control system is further configured to control movement of the dancer in response to the detected wire tension.

13. The cutting machine of claim 6, further comprising the cleaning device of claim 1.

14. A method of cutting an ingot, the method comprising:
a. attaching an ingot onto a carrier;
b. lowering the ingot to contact a plurality of wires;
c. flowing water onto the plurality of wires and the ingot during cutting; and
d. submerging cut portions of the ingot in water without submerging the plurality of wires.

15. The method of claim 14, further comprising periodically raising the ingot during operation such that the plurality of wires are run against the cut portions of the ingot during the raising, thereby improving surface quality of the cut portions of the ingot.

16. The method of claim 14, wherein the plurality of wires are formed from a wire, and further comprising cleaning the wire after cutting by passing the wire through a wire cleaning device prior to winding the wire onto a wire receiver drum.

17. The method of claim 16, further comprising positioning the wire with respect to the wire receiver drum by passing the wire through a wire displacement sensor after cleaning the wire and prior to winding the wire onto the wire receiver drum.

18. The method of claim 16, further comprising, before cutting, positioning the wire relative to a wire feeder drum by passing the wire through a wire displacement sensor after unwinding the wire from a wire feeder drum.

19. The method of claim 17, further comprising controlling tension of the wire by controlling movement of a dancer around which the wire is passed, wherein movement of the dancer is in response to wire tension detected by a wire tension sensor.

20. The method of claim 18, wherein controlling tension of the wire comprises moving the dancer to increase total distance travelled by the wire to increase wire tension when the detected wire tension is lower than a predetermined wire tension, and moving the dancer to decrease total distance travelled by the wire to decrease wire tension when the detected wire tension is higher than the predetermined wire tension.
